(19) United States
(12) Patent Application Publication
(10) Pub. No.: US 2005/0282069 A1
(43) Pub. Date: Dec. 22, 2005

(54) Rechargeable battery pack and method for separating core pack from case

(76) Inventors: Joong Heon Kim, Cheonan-si (KR); Hyung Bok Lee, Seoul (KR)

Correspondence Address: MCGUIREWOODS, LLP, 1750 TYSONS BLVD, SUITE 1800, MCLEAN, VA, 22102, US

(21) Appl. No.: 11/139,985

(22) Filed: May 31, 2005

(30) Foreign Application Priority Data
May 31, 2004 (KR) 2004-0039167

(51) Int. Cl. H01M 2/08; H01M 2/02; B23P 19/00; H01M 2/04

(52) U.S. Cl. 429/185; 429/175; 429/176; 29/426.1

(57) ABSTRACT

A rechargeable battery pack and a method for separating a core pack from a case make it possible to easily separate the core pack from the case without causing any damage to the surface of the core pack. A core pack may need to be separated from the case during a process for forming a battery pack if it is improperly or insecurely fastened initially. The rechargeable battery pack includes a core pack that has an electrode assembly composed of a positive electrode plate, a separator, and a negative electrode plate. The core pack further comprises a sheath member for sealing the electrode assembly together with an electrolyte and a protective circuit module that is fastened on the exterior of the sheath member while being coupled to the electrode assembly. The rechargeable battery pack also includes a case that is adapted to seat and fix the core pack thereon that has at least one trench formed on the bottom surface on which the core pack is seated. In addition, the battery pack includes an adhesive for gluing the core pack to the bottom surface of the case and a cover for covering the case and protecting the core pack from its external surroundings.

### CROSS REFERENCE TO RELATED APPLICATION

This application claims priority to and the benefit of Korean Patent Application No. 2004-0039167 filed on May 31, 2004, which is hereby incorporated by reference for all purposes as if fully set forth herein.

### BACKGROUND OF THE INVENTION

1. Field of the invention

The present invention relates to a rechargeable battery pack and a method for easily separating a core pack from a case without causing any damage to the surface of the core pack.

2. Description of the Prior Art

As generally known in the art, a rechargeable battery pack refers to a battery that is used as a power source in a device and is also called an “auxiliary battery.”

A battery pack generally comprises a core pack that has an electrode assembly, an electrolyte, a sheath member for sealing the electrode assembly and the electrolyte, and a protective circuit module that is positioned on the surface of the core pack. A battery pack further comprises a case on which the core pack is seated, an adhesive for gluing the core pack to the case, and a cover for the case.

The core pack of a battery pack may be glued to its casein an incorrect position due to a defect of the gluing equipment, an error in positioning the adhesive, or an error in the alignment of the core pack and the case. If incorrectly glued to the case, the core pack may vibrate inside the case after the battery pack fully assembled and may generate a noise.

When the core pack is improperly glued to the case, the core pack must be separated from the case and glued again. However, the separation process is hard to perform because the adhesion force of the adhesive is very strong. Even after the separation process, remnants of the used adhesive may remain on the core pack and the case. This makes the regluing processes more difficult.

Furthermore, the surface of the core pack may be damaged during the separation process. This may degrade the appearance of the core pack or render it unusable. In addition, the surface of the sheath member may bulge or deform because it is not easily separated from the adhesive. Alternatively, the sheath member may fracture and cause the internal electrolyte to leak.

### SUMMARY OF THE INVENTION

The present invention provides a rechargeable battery pack that allows the core pack to easily be separated from the case.

The present invention also provides a method for easily separating the core pack from the case.

Additional features of the invention will be set forth in the description which follows, and in part will be apparent from the description, or may be learned by practice of the invention.

The present invention discloses a rechargeable battery pack that comprises a core pack that has an electrode assembly that comprises a positive electrode plate, a separator, and a negative electrode plate, a sheath member that seals the electrode assembly together with an electrolyte, and a protective circuit module that is fastened to the exterior of the sheath member while being coupled to the electrode assembly. The battery pack further comprises a case that is adapted to seat and fix the core pack thereon and has at least one trench formed on its bottom surface on which the core pack is seated. In addition, the battery pack comprises an adhesive for gluing the core pack to the bottom surface of the case and a cover for covering the case and protecting the core pack from external environments.

The present invention also discloses a rechargeable battery pack comprising a voltage generation means for generating a predetermined voltage, a casing means for seating the voltage generation means on its bottom surface which has at least one trench formed thereon, a gluing means for gluing the voltage generation means to the bottom surface of the casing means, and a covering means for covering the casing means and protecting the voltage generation means from external environments.

The present invention also discloses a method for separating a core pack from a case that comprises the steps of preparing a core pack that has an electrode assembly, an electrolyte, a sheath member for sealing the electrode assembly and the electrolyte. A protective circuit module is positioned on the exterior of the sheath member while being coupled to the electrode assembly. Then the core pack is glued to the bottom surface of a case using an adhesive that is interposed between them. The adhesive strength of the bond between the core pack and the case is tested. If the test result is out of an acceptable range, the core pack and the case are dipped into a solution to a predetermined depth to decrease the adhesion force of the adhesive so that the core pack may be separated from the case.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1A is a perspective view that shows a rechargeable battery pack according to an exemplary embodiment of the present invention.

FIG. 1B is an exploded perspective view of the rechargeable battery pack shown in FIG. 1A.

FIG. 1C is an exploded perspective view that shows only a core pack of the rechargeable battery pack shown in FIG. 1B.

FIG. 2A is a perspective view that shows a rechargeable battery pack according to another exemplary embodiment of the present invention.

FIG. 2B is an exploded view of the rechargeable battery pack shown in FIG. 2A.

FIG. 3A is a sectional view taken along line 1-1 of FIG. 1A.

FIG. 3B is a sectional view that magnifies area 2 of FIG. 3A.

FIG. 3C is a top view that shows a rechargeable battery pack according to an exemplary embodiment of the present invention.

FIG. 4 is a top view that shows a rechargeable battery pack according to another exemplary embodiment of the present invention.

FIG. 5 is a top view that shows a rechargeable battery pack according to another embodiment of the present invention.

FIG. 6A illustrates a method for separating a core pack from a case according to an exemplary embodiment of the present invention, wherein a rechargeable battery pack is dipped into a solution.

FIG. 6B is a sectional view taken along line 3-3 of FIG. 6A.

### DETAILED DESCRIPTION OF THE PREFERRED EMBODIMENTS

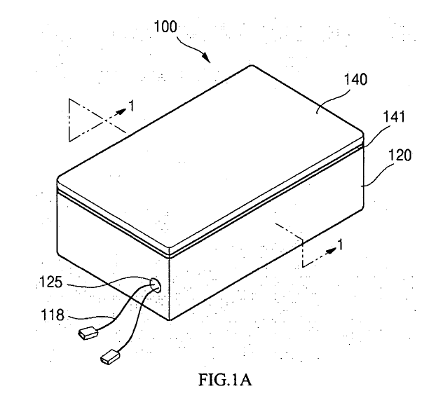

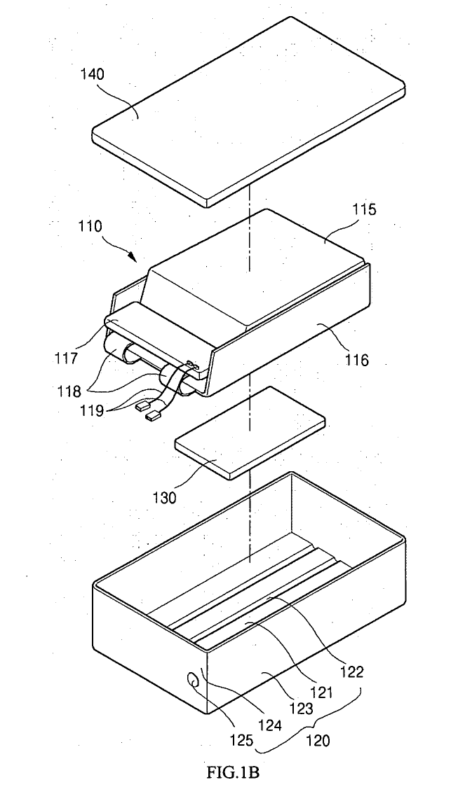

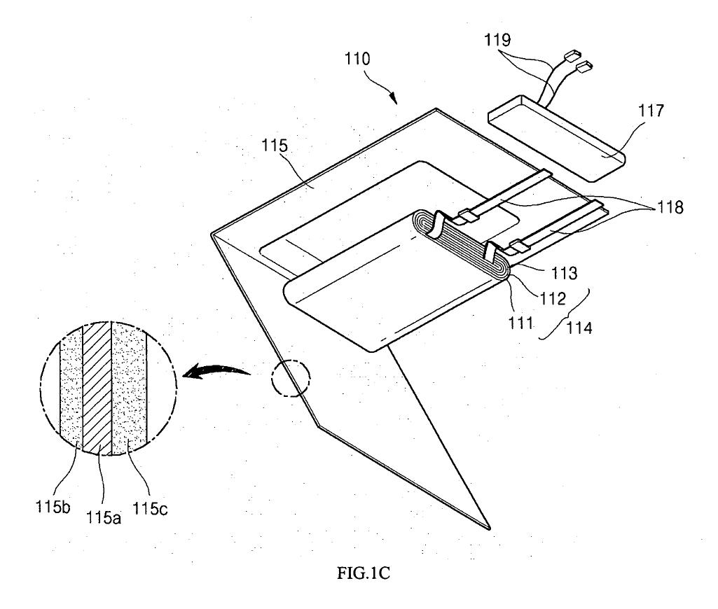

FIG. 1A is a perspective view that shows a rechargeable battery pack according to an exemplary embodiment of the present invention. FIG. 1B is an exploded perspective view of the rechargeable battery pack shown in FIG. 1A. FIG. 1c is an exploded perspective view that shows only a core pack of the rechargeable battery pack shown in FIG. 1B.

1A1B1A1B As shown in FIG. 1A, FIG. 1B, and FIG. 1C, a rechargeable battery pack 100 according to an exemplary embodiment of the present invention generally comprises a core pack 110, a case 120 on which the core pack 110 is seated, an adhesive 130 for gluing the core pack 110 to the case 120, and a cover 140 for covering the upper portion of the case 120.

The core pack 110 includes an electrode assembly 114 that is formed by winding or laminating a positive electrode plate 111, a separator 112, and a negative electrode plate 113. It also comprises a sheath member 115 for sealing the electrode assembly 114 while it is impregnated with an electrolyte (not shown), and a protective circuit module 117 that is positioned on the exterior of the sheath member 115 and is coupled to the electrode assembly 114. The electrode assembly 114 and the protective circuit module 117 are coupled to each other by electrode tabs 118. The protective circuit module 117 includes lead wires 119 that extend to the exterior of the case 120 that may be coupled to external devices.

Although the edge 116 of the sheath member 115 is shown to bend upward and the protective circuit module 117 is shown to lie down in FIG. 1B, the present invention is not limited to such a configuration of the core pack 110. For example, the shape of or the type of bend at the edge 116 of the sheath member 115 of the core pack 110 may be modified in various ways as can the shape or position of the protective circuit module 117. In addition, although the core pack 110 is shown to be glued to the case 120 while the protective circuit module 117 is positioned on the upper portion of the core pack 110 in FIG. 1C, the method of gluing is not limited in the present invention. For example, the core pack 110 may be glued to the case 120 upside down, in contrast to the position shown in the FIG. 1B. The present invention can use any manufactured core pack 110 and all kinds of sheath members 115.

For example, the sheath member 115 may be a flexible pouch that has a metallic layer 115a, a first insulating layer 115b that is formed on a surface of the metallic layer 115a, and a second insulating layer 115c that is formed on the other surface thereof. The metallic layer 115a may be made of any material including, but not limited to steel, stainless steel, aluminum, and an equivalent thereof. The first insulating layer 115b may be made of any material such as nylon, polyethylene terephthalate (PET), and an equivalent thereof. The second insulating layer 115c may be made of any material including, but not limited to cast polypropylene (CPP) and an equivalent thereof. The first and second insulating layers 115b and 115c become the external and internal surfaces of the sheath member 115, respectively.

The case 120 includes a bottom surface 121 that has the shape of a substantially rectangular plate and lateral walls 123 and 124 that extend up to a predetermined height from the four sides of the bottom surface 121. The lateral walls 123 and 124 include a longitudinal lateral wall 123 and a traverse lateral wall 124. The case 120 may be made of a conventional plastic resin or an equivalent thereof, but is not limited herein.

The case 120 has at least one trench 122 that is formed on the bottom surface 121 to which the core pack 110 is glued with the adhesive 130. The trench 122 may be formed with a predetermined spacing along the longitudinal direction of the bottom surface 121. Particularly, the trench 122 may be formed parallel to the longitudinal lateral wall 123. The depth of the trench 122 may correspond to 10-90% of the thickness of the case 120, specifically the thickness of the bottom surface 121.

The traverse lateral wall 124 has a through-hole 125 that is formed thereon so that the lead wire 119 can be drawn to the exterior from the core pack 110.

The adhesive 130 is used to firmly glue the core pack 110 to the bottom surface 121 of the case 120. Specifically, the adhesive 130 directly fastens the surface of the sheath member 115 of the core pack 110 to the bottom surface 121, thereby preventing the core pack 110 from vibrating or escaping from inside the case 120. The adhesive 130 may be a double-faced adhesive tape that has both surfaces coated with any sticky substance including, but not limited to non-woven fabric, acrylic, foam, and film or an equivalent thereof. For example, a conventional epoxy-based substance may be used for the adhesive 130.

The adhesive 130 is preferably made of material that has an adhesion force that decreases, and which dissolves when it is contacted with a solution such as xylene, toluene, methyl ethyl ketone, or an equivalent thereof. This property of the adhesive 130 allows the solution to easily separate the core pack 110 from the case 120.

Although the overall area of the adhesive 130 is shown to be smaller than the area of the core pack 110, the present invention is not limited thereto. For example, the area of the adhesive 130 may be larger than that of the core pack 110 or equal to that of the bottom surface 121 of the case 120.

The cover 140 has the shape of a substantially rectangular plate and is fastened to the lateral walls 123 and 124 of the case 120 by an adhesive 141. The sealing of the core pack 110 by the case 120 and the cover 140 in this manner protects the core pack 110 from the 5 external environment and allows the case 120 to be mounted on external devices.

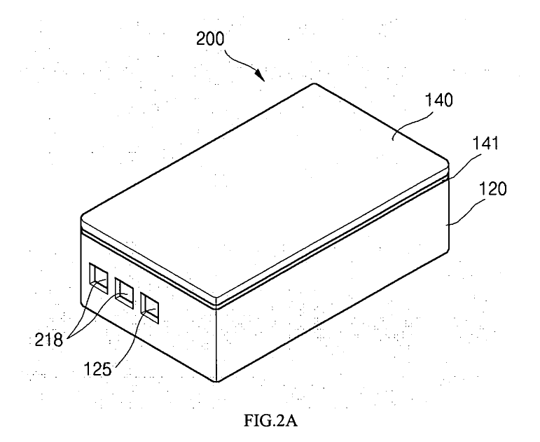

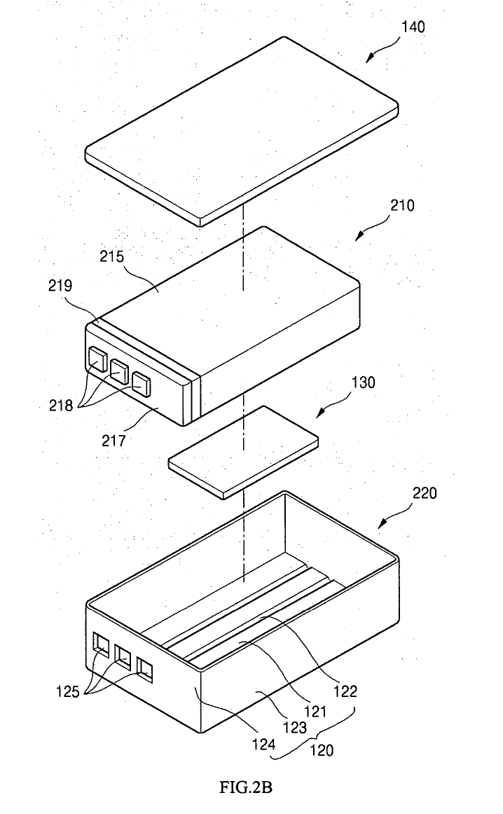

FIG. 2A is a perspective view of a rechargeable battery pack according to another exemplary embodiment of the present invention. FIG. 2B is an exploded view of the rechargeable battery pack shown in FIG. 2A.

As shown in FIG. 2A and FIG. 2B, a rechargeable battery pack 200 according to another exemplary embodiment of the present invention generally comprises a core pack 210, a case 120 on which the core pack 210 is seated, an adhesive 130 for gluing the core pack 210 to the case 120, and a cover 140 for covering the upper portion of the case 120.

The configuration of the case 120, the adhesive 130, and the cover 140 is similar to that mentioned above and the differences will mainly be described herein.

As shown in the drawings, a sheath member 215, which constitutes the exterior of the core pack 210 of the rechargeable battery pack 200 according to the present invention, may be a metallic can. The metallic can may be made of steel, stainless steel, aluminum, or an equivalent thereof, but is not limited herein. When the sheath member 215 is made of a metallic can, a protective circuit module 217 may be glued and fixed to a lateral surface of the sheath member 215 by a resin 219. The protective circuit module 217 is provided with terminals 218.

The case 120 has a number of through-holes 125 that are formed on a surface 124 of the case 120 at locations that correspond to the terminals 218 that are formed on the protective circuit module 217. The terminals 218 are exposed to the exterior of the case 120 via the through-holes 125.

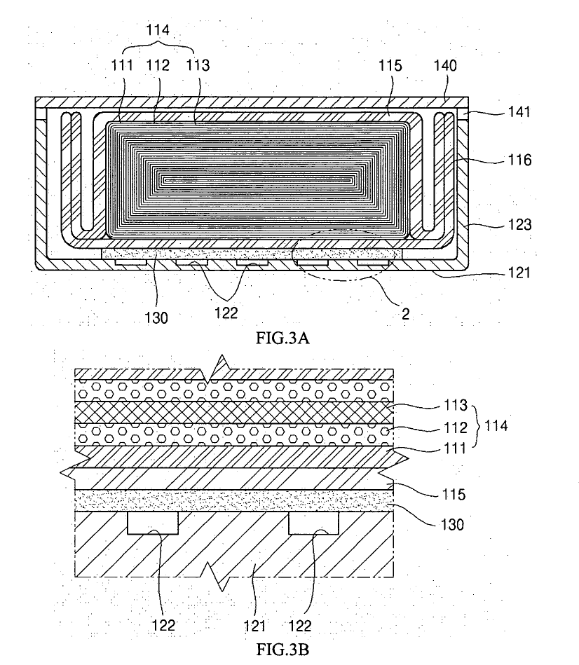

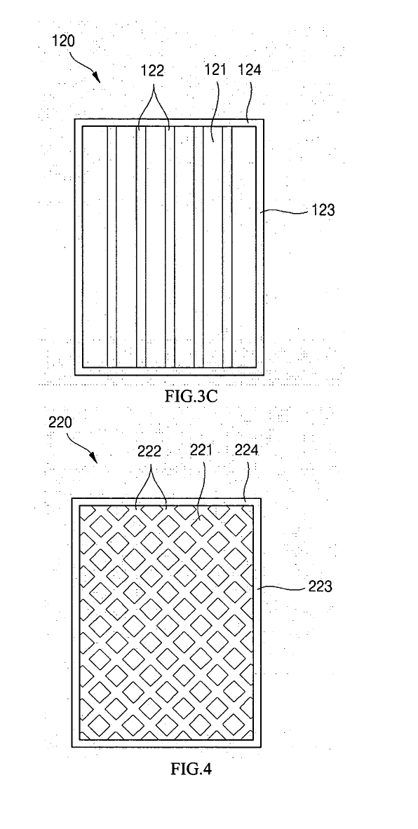

FIG. 3A is a sectional view taken along line 1-1 of FIG. 1A. FIG. 3B is a sectional view that magnifies area 2 of FIG. 3A. FIG. 3C is a top view that shows a case of a rechargeable battery pack according to an exemplary embodiment of the present invention.

As shown in FIG. 3A, FIG. 3B, and FIG. 3C, the case 120 has a number of trenches 122 that are formed on the bottom surface 121 of the case 120 along the longitudinal lateral wall 123. The trenches 122 act as passages through which a xylene, toluene, methyl ethyl ketone, or similar solution can pass in order to decrease the adhesion force of the adhesive 130, if the adhesion is poor. Therefore, the more trenches there are, the easier it is to correct a poor adhesion.

However, the trenches 122 reduce the adhesion area of the adhesive 130 and may degrade the adhesion force themselves. Accordingly, the number of trenches 122 must be carefully determined in consideration of such conditions. Although the sectional shape of the trenches 122 that are formed on the bottom surface 121 is shown to be a rectangle, this does not limit the shape of the trenches 122. For example, the trenches 122 may have a semi-circular, inverted triangle, or polygonal cross-sections.

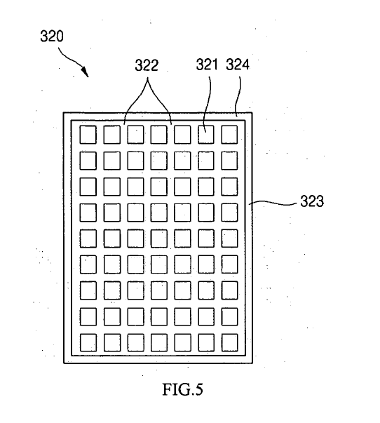

FIG. 4 is a top view of a rechargeable battery pack according to another exemplary embodiment of the present invention.

As shown in FIG. 4, the trenches 222 may be formed on the bottom surface 221 of the case 220 with a predetermined spacing while crossing one another along both diagonal directions, i.e., in a substantially “X”-shaped configuration. Such a configuration of the trenches 222 enables the solution to reach every region of the adhesive faster and more uniformly when separating the core pack from the case.

FIG. 5 is a top view that shows a rechargeable battery pack according to another exemplary embodiment of the present invention.

As shown in FIG. 5, the trenches 322 may be formed on the bottom surface 321 of the case 320 with a predetermined spacing while crossing one another along the longitudinal and traverse directions of the bottom surface 321 (i.e., along the longitudinal lateral wall 323 and the traverse lateral wall 324 thereof) in a substantially “+”-shaped configuration. Such a configuration of the trenches 322 enables the solution to reach every region of the adhesive faster and more uniformly when separating the core pack from the case.

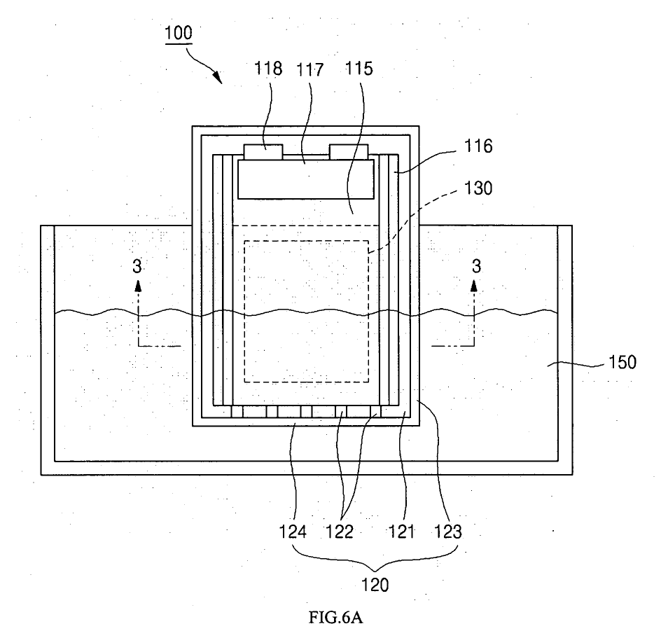

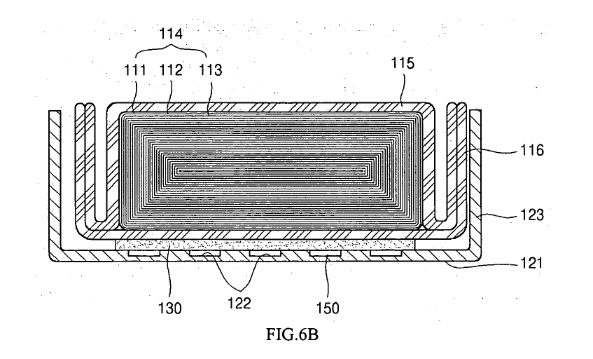

FIG. 6A shows a method for separating a core pack from a case according to the present invention, wherein a rechargeable battery pack is dipped into a solution. FIG. 6B shows a sectional view taken along line 3-3 of FIG. 6A.

After a core pack 110 is glued to a case 120 with an adhesive 130 interposed between them, a test is generally performed to verify that the core pack 110 has been firmly glued to the case 120 in the correct position. If the test results confirm that the core pack 110 is out of the correct position or if it vibrates inside the case 120, the core pack 110 is separated from the case 120 and the gluing process is repeated.

According to the present invention, the core pack 110 and the case 120 are dipped into a solution 150 for a period of time to separate the core pack 110 and the case 120, instead of forcibly removing the core pack 110 from the case 120.

The core pack 110 and the case 120 are dipped into a solution 150 comprising xylene, toluene, methyl ethyl ketone, or an equivalent thereof, for example, for a period of time so that the adhesion force of the adhesive 130 decreases or the adhesive 130 dissolves. Any material may be used in the solution 150 as long as it does not react with the core pack 110 and the case 120.

Furthermore, the bottom surface 121 of the case 120, to which the adhesive 130 adheres, has at least one trench 122 that is formed along the longitudinal direction of the case 120. It also has at least one trench 122 that is formed while crossing another trench 122 along the diagonal direction of the case 120, or at least one trench 122 that is formed on the case 120 while crossing another trench 122 along the longitudinal and traverse directions thereof, so that the solution 150 can reach every region of the adhesive 130 faster and more uniformly.

The depth of the trench 122 corresponds to 10-90% of the thickness of the case 120. The adhesive 130 may be a double-faced adhesive tape that has both surfaces coated with any sticky substance including, but not limited to non-woven fabric, acrylic, foam, and film. The features of the trench 122 of the case 120 and the adhesive 130 have been described with reference to the second battery pack 100 and repeated descriptions thereof will be omitted.

The protective circuit module 117 must face upward when dipping the core pack 110 and the case 120 into the solution 150 to prevent the protective circuit module 117, which is fastened on the core pack 110, from being contaminated by the solution 150.

After the dipping, the adhesion force of the adhesive 130 decreases or the adhesive 130 dissolves in the solution 150. This allows the core pack 110 to easily be separated from the case 120. The adhesive 130 can also be easily peeled off from the case 120 and the core pack 110.

In addition, any damage to the core pack 110, specifically bulges, deformation, or fracture of the surface of the sheath member 115 can be avoided by reducing the adhesion force of the adhesive 130 or by the dissolving the adhesive 130 itself. This makes it possible to reglue the core pack 110 to the case 120 conveniently without any decrease in production yield of the battery pack 100.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A rechargeable battery pack, comprising:
a core pack that has an electrode assembly including of a positive electrode plate, a separator, and a negative electrode plate, a sheath member for sealing the electrode assembly with an electrolyte, and a protective circuit module;
a case that is adapted to seat and fix the core pack thereon;
an adhesive that couples the core pack to the bottom surface of the case; and
a cover that covers the case,
wherein the case has at least one trench that is formed on a surface on which the core pack is positioned.

2. The rechargeable battery pack of claim 1,
wherein the trench is formed with a predetermined spacing along the longitudinal direction of a surface of the case.

3. The rechargeable battery pack of claim 1,
wherein a trench is formed with a predetermined spacing while crossing another trench along both diagonal directions of a surface of the case.

4. The rechargeable battery pack of claim 1,
wherein a trench is formed with a predetermined spacing while crossing another trench along the longitudinal and traverse directions of a surface of the case.

5. The rechargeable battery pack of claim 1,
wherein the trench's depth is 10-90% of the thickness of the case.

6. The rechargeable battery pack of claim 1,
wherein the adhesive is a double-faced adhesive tape that is coated with any sticky substance selected from a group consisting of non-woven fabric, acrylic, foam, and film.

7. The rechargeable battery pack of claim 1,
wherein the adhesive is comprised of material for which the adhesion force of is decreased by contact with a solution selected from a group consisting of xylene, toluene, and methyl ethyl ketone.

8. The rechargeable battery pack of claim 1,
wherein the sheath member is a flexible pouch that has a metallic layer,
wherein a first insulating layer is formed on a surface of the metallic layer, and
wherein a second insulating layer is formed on another surface of the metallic layer.

9. The rechargeable battery pack of claim 8,
wherein the metallic layer is made of material selected from a group consisting of steel, stainless steel, and aluminum;
wherein the first insulating layer is made of material selected from a group consisting of nylon and polyethylene terephthalate (PET); and
wherein the second insulating layer is made of cast polypropylene (CPP).

10. The rechargeable battery pack of claim 1,
wherein the sheath member is a can made of metal.

11. The rechargeable battery pack of claim 10,
wherein the metal is chosen from steel, stainless steel, and aluminum.

12. A rechargeable battery pack, comprising:
a voltage generation means for generating a predetermined voltage;
a casing means for positioning the voltage generation means on a surface that has at least one trench formed thereon;
a gluing means for gluing the voltage generation means to a surface of the casing means; and
a covering means for covering the casing means.

13. The rechargeable battery pack of claim 12,
wherein a trench is formed with a predetermined spacing along the longitudinal direction of a surface of the casing means.

14. The rechargeable battery pack of claim 12,
wherein a trench is formed with a predetermined spacing while crossing another trench along both diagonal directions of a surface.

15. The rechargeable battery pack of claim 12,
wherein a trench is formed with a predetermined spacing while crossing another trench along the longitudinal and traverse directions of a surface.

16. A method for separating a core pack from a case, comprising:
preparing a core pack including an electrode assembly, an electrolyte, a sheath member for sealing the electrode assembly and the electrolyte, and a protective circuit module;
gluing the core pack to a surface of a case using an adhesive;
testing the adhesion strength between the core pack and the case and, if the test result is out of a reference range, dipping the core pack and the case into a solution to a predetermined depth; and
separating the core pack from the case.

17. The method of claim 16,
wherein the case has at least one trench that is formed on a surface,
wherein the adhesive is glued with a predetermined spacing along the longitudinal direction of the surface.

18. The method of claim 16,
wherein the case has at least one trench formed on a surface,
wherein the adhesive is glued with a predetermined spacing while crossing one another along both diagonal directions of the surface.

19. The method of claim 16,
wherein the case has at least one trench formed on a surface,
wherein the adhesive is glued with a predetermined spacing while crossing one another along the longitudinal and traverse directions of the surface.

20. The method of claim 17,
wherein the trench's depth is 10-90% of the thickness of the case.

21. The method of claim 16,
wherein the adhesive is a double-faced adhesive tape that has both surfaces coated with any sticky substance selected from a group consisting of non-woven fabric, acrylic, foam, and film.

22. The method of claim 16,
wherein the solution is selected from a group consisting of xylene, toluene, and methyl ethyl ketone.

23. The method of claim 16,
wherein the solution is adapted to react only with the adhesive.
